(19) United States
(12) Patent Application Publication
(10) Pub. No.: US 2014/0068122 A1
(43) Pub. Date: Mar. 6, 2014

(54) METHOD, SYSTEM AND PROCESSOR-READABLE MEDIA FOR ASCERTAINING A MAXIMUM NUMBER OF CONTIGUOUS BITS OF LOGICAL ONES OR ZEROS WITHIN A PARALLEL WORD OF ARBITRARY WIDTH

(71) Applicants: Qiao Shen, Shanghai (CN); Samuel Khoo, Macungie, PA (US); Wen Zhu, Shanghai (CN); Lane A. Smith, Easton, PA (US)

(72) Inventors: Qiao Shen, Shanghai (CN); Samuel Khoo, Macungie, PA (US); Wen Zhu, Shanghai (CN); Lane A. Smith, Easton, PA (US)

(73) Assignee: LSI Corporation

(21) Appl. No.: 13/604,048

(22) Filed: Sep. 5, 2012

(51) Int. Cl. G06F 13/14

(52) U.S. Cl. 710/100

(57) ABSTRACT

Methods, systems and processor-readable media for reducing the width of a logical comparison. A width of a logical comparison based on a previous result generated can be recursively reduced from a data stream and a maximum count of consecutive ones or consecutive zeros determined from the serial data stream based on a priority encoder within a single clock cycle in order to avoid a use of complex functions. In this manner, the maximum number of the consecutive ones or the consecutive zeros in a parallel word bus within the single dock cycle can be ascertained.

### TECHNICAL FIELD

Embodiments are generally related to electronic systems including storage systems and controllers. Embodiments are additionally related to SOC (System-on-Chip) devices, components, and devices thereof. Embodiments are also related to PHY layer logic (Physical ink control logic) and coupled devices,

### BACKGROUND OF THE INVENTION

In a variety of electronic systems, including storage systems, a number of devices (e.g., storage devices) of the system may be under control of a common control unit. For example, in storage systems each one or more storage controllers may be coupled with a plurality of storage devices. The controllers and the storage devices each consume significant power even when in an idle state. Still more specifically, the communication interfaces in the storage controllers and the storage devices consume power even when idle if the communication medium and/or protocol require that an idle communication path continuously send and receive signals during an idle period in which no application data is exchanged between the devices. For example, in a Serial Attached SCSI (SAS) environment, the PHY layer logic (physical link control logic) of coupled devices exchange idle words during such idle periods.

Timing problems are often inherent with prior art PHY devices and systems. Meeting timing while minimizing the die area is an important goal in any developing efficient Phy layer logic. For example, a timing closure problem was encountered during the development of Phy IP used for SAS Tx training invalid marker detection logic. The leading industry synthesis tool was unable to synthesize the rtl into logical gates while meeting the timing of this path within the required 3.33 ns clock period with a typical rtl coding style. This optimized algorithm yielded approximately an 8X improvement in timing over the previous code.

Previous attempts have been made to address this problem. One solution involves iteratively counting and tracking the consecutive number of ones or zeros over the entire width of the parallel data bus to determine the maximum value. Another solution involves breaking up the above method into multiple parallel blocks in order to help speed up the process, which requires the notion of “carry-in” and “carry-out.” Primary disadvantages of both of these attempts include the silicon area to implement the logic and/or an inability to meet timing for bus frequencies that exceed 100 MHz.

Thus, there is an ongoing challenge to manage communication paths between devices, for example, between SAS devices, and to reduce wasteful power consumption.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for methods, systems, and devices for differentiating invalid pattern markers from valid pattern markers.

It is another aspect of the disclosed embodiments to provide methods, systems, and devices for ascertaining the maximum number of consecutives ones or zeros in an N-bit wide parallel word bus within a single dock cycle of an application in a SOC.

It is a further aspect of the disclosed embodiments to provide for the use of a simple priority encoder to avoid the use of complex functions in a SOC in order to achieve efficient power usage thereof.

The aforementioned aspects and other objectives and advantages can now be achieved as described herein. Methods, systems and processor-readable media are disclosed for reducing the width of a logical comparison. In some embodiments, steps or logical operations can be provided for recursively reducing from a serial data stream, a width of a logical comparison based on a previous result generated, and determining a maximum count of consecutive ones or consecutive zeros from the serial data stream based on a priority encoder within a single clock cycle in order to avoid a use of complex functions.

In another embodiment, a step or logical operation can be implemented for ascertaining the maximum number of the consecutive ones or the consecutive zeros in a parallel word bus within the single clock cycle. In some embodiments, the parallel word bus can be configured as an N-bit wide parallel word bus. In other embodiments, a step or logical operation can be implemented for determining the maximum count of the consecutive ones and the consecutive zeros after de-serializing at least a portion of the serial data stream into N-bit (e.g., 40 bit) parallel words via the parallel word bus. In other embodiments, the parallel word bus can be configured as, for example, a 10-bit input bus. In yet other embodiments, a step or logical operation can be implemented for differentiating an invalid pattern marker from a valid marker based on a range of patterns of the consecutive ones and the consecutive zeros from the serial data stream.

In another embodiment, a system for reducing the width of a logical comparison can be implemented. Such a system can include, for example, a processor and a computer-usable medium embodying computer program code. The computer program code can include instructions executable by the processor and configured, for example, for recursively reducing from a serial data stream, a width of a logical comparison based on a previous result generated; and determining a maximum count of consecutive ones or consecutive zeros from the serial data stream based on a priority encoder within a single clock cycle in order to avoid a use of complex functions. In another embodiment, such instructions can be further configured for ascertaining the maximum number of the consecutive ones or the consecutive zeros in a parallel word bus within the single clock cycle. In such a system embodiment, the parallel word bus can include an N-bit wide parallel word bus.

In other embodiments, such instructions can be further configured for determining the maximum count of the consecutive ones and the consecutive zeros after de-serializing at least a portion of the serial data stream into N-bit parallel words via the parallel word bus. In some system embodiments, the parallel word bus may be, for example, a 10-bit input bus. In yet other embodiments, such instructions can be further configured for differentiating an invalid pattern marker from a valid marker based on a range of patterns of the consecutive ones and the consecutive zeros from the serial data stream.

In still another embodiment, a processor-readable medium storing code representing instructions to cause a process for reducing the width of a logical comparison can be implemented. Such code can include code to, for example: recursively reduce from a serial data stream, a width of a logical comparison based on a previous result generated; and determine a maximum count of consecutive ones or consecutive zeros from the serial data stream based on a priority encoder within a single dock cycle in order to avoid a use of complex functions.

In still other embodiments, such code can further include code to ascertain the maximum number of the consecutive ones or the consecutive zeros in a parallel word bus within the single clock cycle. In some processor-readable embodiments, the parallel word bus can be an N-bit wide parallel word bus. In yet other embodiments, such code can further include code to determine the maximum count of the consecutive ones and the consecutive zeros after de-serializing at least a portion of the serial data stream into, for example, N=40 bit (e.g., 40 bit) parallel words via the parallel word bus. In still other embodiments, such code can further include code to differentiate an invalid pattern marker from a valid marker based on a range of patterns of the consecutive ones and the consecutive zeros from the serial data stream.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a system for implementing backchannel training invalid marker detect logic, in accordance with the disclosed embodiments; and

FIG. 2 illustrates a 10-bit bus example, which is broken up into three stages of processing, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

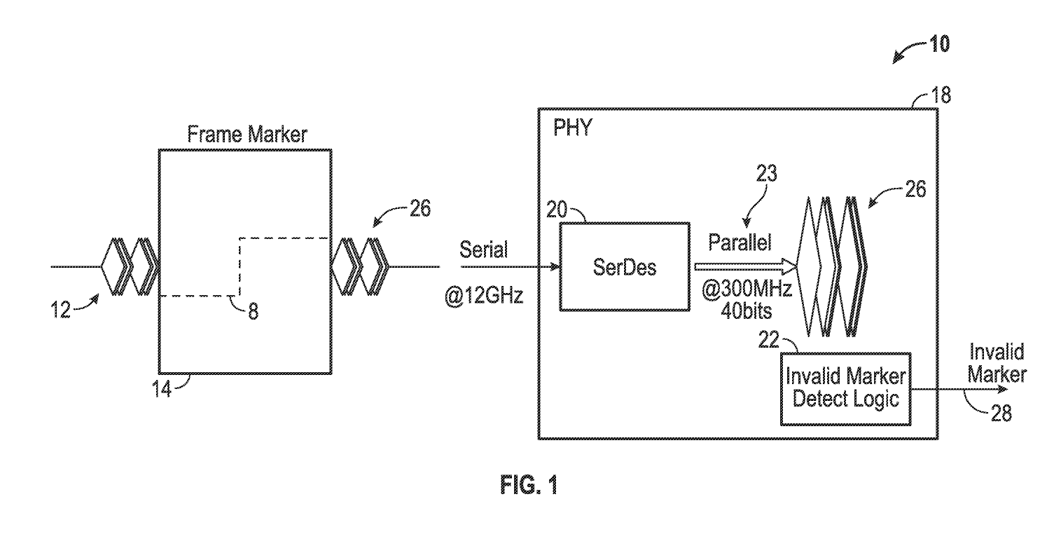

FIG. 1 illustrates a schematic diagram of a system 10 for implementing invalid marker detection logic, in accordance with the disclosed embodiments. In general, the system 10 can include input 12 to an invalid frame marker 14. Output from the invalid frame marker 14 can be fed as a serial data stream to the PHY layer 18, and specifically to a Serializer/Deserializer (SerDes—pronounced sir-deez) 20. Note that the SerDes 20 can be configured as a pair of functional blocks for use in high-speed communications to compensate for limited input/output. These blocks convert data between serial data and parallel interfaces in each direction. The term “SerDes” can be used generically to refer to interfaces used in various technologies and applications. Output 23 from the SerDes 20 is transmitted in a parallel data stream 26 (e.g., at 300 MHz, 40 bits) for processing by the invalid marker detects logic 22. The invalid marker 28 is then output from the invalid marker detect logic.

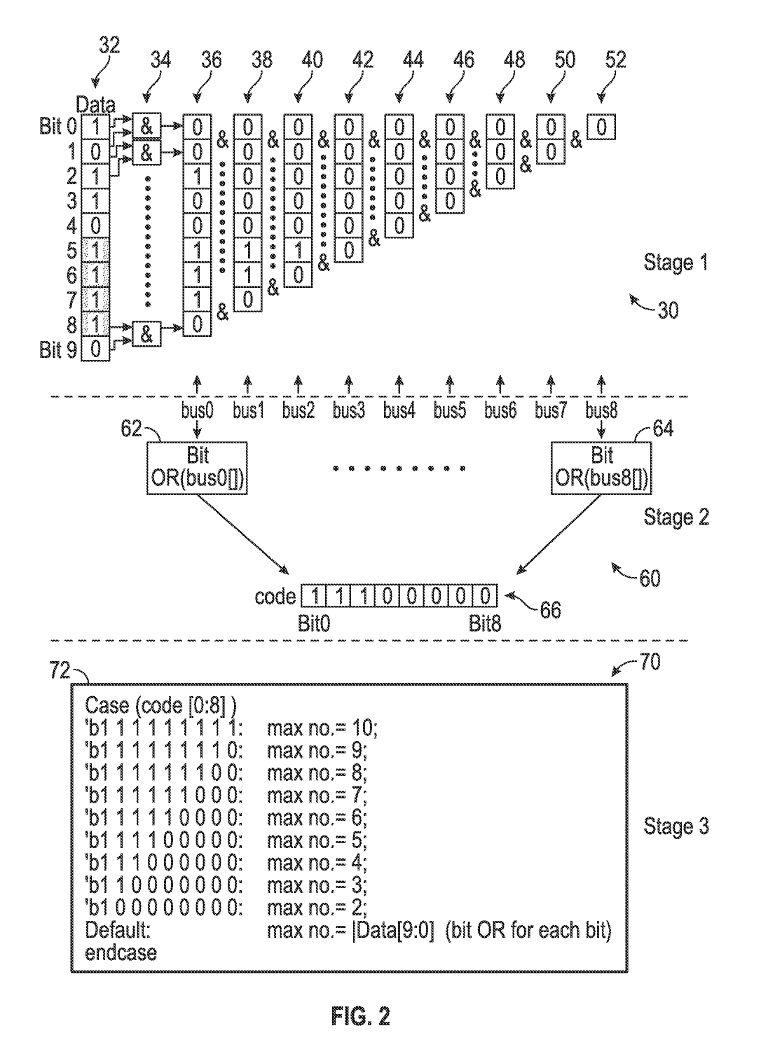

In some situations (e.g., in SAS3 PHY layer spec), it is a requirement to differentiate an invalid pattern marker from a valid marker based on a range of contiguous 1 and 0 patterns in the received serial data stream, as shown in, for example, system 10 of FIG. 1. The determination is applied after the data stream is de-serialized into 40-bit parallel words, as shown, for example, by output 23 in FIG. 1. To accurately detect the invalid pattern marker using the 40-bit word at either word boundary, the last 10-bits of the previous data word and first 10-bits of the next data word are concatenated to form a 60-bit word for evaluation. The optimized algorithm is illustrated with an actual example in FIG. 2, which explains this approach.

FIG. 2 illustrates a 10-bit bus example, which is broken up into three stages of processing, in accordance with the disclosed embodiments. Three stages are shown in FIG. 2, which includes a first stage 30 (i.e., stage 1), a second stage 60 (i.e., stage 2), and a third stage 70 (i.e., stage 3). Data blocks 32, 34, 36, 38, 40, 42, 44, 46, 48, 50, and 52 are shown with respect to the first stage 30. In the second stage 60, block 62 represents “Bit OR(bus0[ ])” and block 64 represents Bit OR(bus8[ ])”. A row 66 indicates code with respect to Bit0 to Bit8. Finally, block 72 is shown with respect to stage 70 and indicates the actual case code through default and endcase values.

The general methodology can be implemented as follows:

1) Starting with the raw data in Data[9:0] (10 bit wide), generate bus 0 (9 bit wide) based on Data[9:0], then bus1 (8 bit wide) based on the resulting bus0, and so on, until bus8 consists of a single bit. The operation to generate the resulting bus in each step is a simple logical AND of two adjacent bits within the input data, for example:
Bus0[0]=Data[0] & Data[1]; Bus0[1]=Data[1] & Data[2]; . . . Bus0[8]=Data[8] & Data[9].
Bus1[0]=Bus0[0] & Bus0[1]; . . . ; Bus1[7]=Bus0[7] & Bus0[8];
Bus8[0]=Bus7[0] & Bus7[1];

A synthesis tool can further optimize this logic into Bus1[0], Bus2[0], Bus3[0], and so on.
Bus1[0]=Bus0[0] & Bus0[1]=Data[0] & Data[1] & Data[1] & Data[2]=Data[0] & Data[1] & Data[2].
Bus2[0]=Bus1[0] & Bus1[1]=Bus0[0] & Bus0[1] & Bus0[1] & Bus0[2]==Data[0] & Data[1] & Data[2] & Data[3];
Bus3[0]=Bus2[0] & Bus2[1]=Bus1[0] & Bus1[1] & Bus1[1] & Bus1[2]=Bus1[0] & Bus1[2]=Bus0[0] & Bus0[1] & Bus0[2] & Bus0[3]=Data[0] & Data[1] & Data[1] & Data[2] & Data[2] & Data[3] & Data[3] & Data[4]=Data[0] & Data[1] & Data[2] & Data[3] & Data[4];

Consequently, every BusX logic can utilize just the raw data input to generate the output with a single level combinatorial logic.

2) Next, the Code value can be calculated from Bus0 to Bus8.
Code[0]=|bus0[ ], Code[1]=|bus1[ ],and so on, where |busX[ ] means bitwise OR operation for the entire busX

3) Finally, the maximum number of contiguous ones of the 10 bit input data can be ascertained with a priority encoder described by case statement as shown in FIG. 2. The same 3-stage process can easily accommodate a generic N-bit data input. The following process can be followed:
1) Generate the BusX where X=[0, N-1].
2) Calculate the resulting Code from BusX, where the width of Code is N-1.
3) Ascertain the max number of contiguous ones by applying a priority encoder onto the Code value.

Based on the foregoing, it can be appreciated that the disclosed embodiments can be implemented as optimized algorithm to ascertain the maximum number of consecutive ones or zeros in an N-bit wide parallel word bus within a single dock cycle of the application in a SOC. Such an approach recursively reduces the width of the logical comparison based on the previous result followed by a final determination of the max count (of consecutive ones or zeros) based on a simple priority encoder, in order to avoid the use of complex functions such as adders. The disclosed embodiments are also extensible to any generic N-bit data input and are easily synthesizable into minimal gate count with low latency for high-speed applications. Advantages of the disclosed embodiments include meeting timing while minimizing the die area with the additional benefit of lower power consumption due to the very efficient implementation of such embodiments and related functions.

A number of embodiments, preferred and alternative, can be implemented. In some embodiments, for example, steps or logical operations can be provided for recursively reducing from a serial data stream, a width of a logical comparison based on a previous result generated, and determining a maximum count of consecutive ones or consecutive zeros from the serial data stream based on a priority encoder within a single clock cycle in order to avoid a use of complex functions.

In another embodiment, a step or logical operation can be implemented for ascertaining the maximum number of the consecutive ones or the consecutive zeros in a parallel word bus within the single clock cycle. In some embodiments, the parallel word bus can be configured as an N-bit wide parallel word bus. In other embodiments, a step or logical operation can be implemented for determining the maximum count of the consecutive ones and the consecutive zeros after de-serializing at least a portion of the serial data stream into 40-bit parallel words via the parallel word bus. In other embodiments, the parallel word bus can be configured as a 10-bit input bus. In yet other embodiments, a step or logical operation can be implemented for differentiating an invalid pattern marker from a valid marker based on a range of patterns of the consecutive ones and the consecutive zeros from the serial data stream. Note that in some embodiments, Stage 1, Stage 2, and/or Stage 3 with two or three pipeline stages for extremely high-speed systems can be implemented, if timing cannot be met in a single clock cycle.

In another embodiment, a system for reducing the width of a logical comparison can be implemented. Such a system can include, for example, a processor and a computer-usable medium embodying computer program code. The computer program code can include instructions executable by the processor and configured, for example, for recursively reducing from a serial data stream, a width of a logical comparison based on a previous result generated; and determining a maximum count of consecutive ones or consecutive zeros from the serial data stream based on a priority encoder within a single clock cycle in order to avoid a use of complex functions. In another embodiment, such instructions can be further configured for ascertaining the maximum number of the consecutive ones or the consecutive zeros in a parallel word bus within the single dock cycle. In such a system embodiment, the parallel word bus can include an N-bit wide parallel word bus.

In other embodiments, such instructions can be further configured for determining the maximum count of the consecutive ones and the consecutive zeros after de-serializing at least a portion of the serial data stream into 40-bit parallel words via the parallel word bus. In some system embodiments, the parallel word bus may be a 10-bit input bus. In yet other embodiments, such instructions can be further configured for differentiating an invalid pattern marker from a valid marker based on a range of patterns of the consecutive ones and the consecutive zeros from the serial data stream.

In still another embodiment, a processor-readable medium storing code representing instructions to cause a process for reducing the width of a logical comparison can be implemented. Such code can include code to, for example: recursively reduce from a serial data stream, a width of a logical comparison based on a previous result generated; and determine a maximum count of consecutive ones or consecutive zeros from the serial data stream based on a priority encoder within a single clock cycle in order to avoid a use of complex functions.

In still other embodiments, such code can further include code to ascertain the maximum number of the consecutive ones or the consecutive zeros in a parallel word bus within the single clock cycle. In some processor-readable embodiments, the parallel word bus can be an N-bit wide parallel word bus. In yet other embodiments, such code can further include code to determine the maximum count of the consecutive ones and the consecutive zeros after de-serializing at least a portion of the serial data stream into 40-bit parallel words via the parallel word bus. In still other embodiments, such code can further include code to differentiate an invalid pattern marker from a valid marker based on a range of patterns of the consecutive ones and the consecutive zeros from the serial data stream.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for reducing the width of a logical comparison, said method comprising:
recursively reducing from a serial data stream, a width of a logical comparison based on a previous result generated; and
determining a maximum count of consecutive ones or consecutive zeros from said serial data stream based on a priority encoder within a single dock cycle in order to avoid a use of complex functions.

2. The method of claim 1 wherein determining said maximum count of said consecutive ones or said consecutive zeros based on a priority encoder within said single dock cycle, further comprises:
ascertaining said maximum number of said consecutive ones or said consecutive zeros in a parallel word bus within said single clock cycle.

3. The method of claim 2 wherein said parallel word bus comprises an N-bit wide parallel word bus.

4. The method of claim 2 further comprising determining said maximum count of said consecutive ones and said consecutive zeros after de-serializing at least a portion of said serial data stream into N-bit parallel words via said parallel word bus.

5. The method of claim 1 further comprising implementing a Stage 1, a Stage 2, and a Stage 3 with at least two pipeline stages for a particularly high processing speed, if timing cannot be met in said single dock cycle.

6. The method of claim 1 further comprising differentiating an invalid pattern marker from a valid marker based on a range of patterns of said consecutive ones and said consecutive zeros from said serial data stream.

7. The method of claim 6 wherein determining said maximum count of said consecutive ones or said consecutive zeros based on a priority encoder within said single clock cycle, further comprises:
ascertaining said maximum number of said consecutive ones or said consecutive zeros in a parallel word bus within said single clock cycle.

8. The method of claim 7 wherein said parallel word bus comprises an N-bit wide parallel word bus.

9. The method of claim 7 further comprising determining said maximum count of said consecutive ones and said consecutive zeros after de-serializing at least a portion of said serial data stream into N-bit parallel words via said parallel word bus.

10. A system for reducing the width of a logical comparison, said system comprising:
a processor;
a computer-usable medium embodying computer program code, said computer program code comprising instructions executable by said processor and configured for:
recursively reducing from a serial data stream, a width of a logical comparison based on a previous result generated; and
determining a maximum count of consecutive ones or consecutive zeros from said serial data stream based on a priority encoder within a single clock cycle in order to avoid a use of complex functions.

11. The system of claim 10 wherein said instructions are further configured for ascertaining said maximum number of said consecutive ones or said consecutive zeros in a parallel word bus within said single dock cycle.

12. The system of claim 11 wherein said parallel word bus comprises an N-bit wide parallel word bus.

13. The system of claim 11 wherein said instructions are further configured for determining said maximum count of said consecutive ones and said consecutive zeros after de-serializing at least a portion of said serial data stream into N-bit parallel words via said parallel word bus.

14. The system of claim 11 wherein said instructions are further configured for implementing a Stage 1, a Stage 2, and a Stage 3 with at least two pipeline stages for a particularly high processing speed, if timing cannot be met in said single dock cycle.

15. The system of claim 11 wherein said instructions are further configured for differentiating an invalid pattern marker from a valid marker based on a range of patterns of said consecutive ones and said consecutive zeros from said serial data stream.

16. A processor-readable medium storing code representing instructions to cause a process for reducing the width of a logical comparison, said code comprising code to:
recursively reduce from a serial data stream, a width of a logical comparison based on a previous result generated; and
determine a maximum count of consecutive ones or consecutive zeros from said serial data stream based on a priority encoder within a single dock cycle in order to avoid a use of complex functions.

17. The processor-readable medium of claim 16 wherein said code further comprises code to ascertain said maximum number of said consecutive ones or said consecutive zeros in a parallel word bus within said single clock cycle.

18. The processor-readable medium of claim 17 wherein said parallel word bus comprises an N-bit wide parallel word bus.

19. The processor-readable medium of claim 17 wherein said code comprises code to determine said maximum count of said consecutive ones and said consecutive zeros after de-serializing at least a portion of said serial data stream into N-bit parallel words via said parallel word bus.

20. The processor-readable medium of claim 16 wherein said code further comprises code to differentiate an invalid pattern marker from a valid marker based on a range of patterns of said consecutive ones and said consecutive zeros from said serial data stream.
